(19) United States
(12) Patent Application Publication
(10) Pub. No.: US 2025/0076734 A1
(43) Pub. Date: Mar. 6, 2025

(54) IMAGING DEVICE

(71) Applicant: NIDEC PRECISION CORPORATION, Tokyo (JP)

(72) Inventor: Yuusuke SUZUKI, Tokyo (JP)

(21) Appl. No.: 18/811,771

(22) Filed: Aug. 22, 2024

(30) Foreign Application Priority Data
Sep. 4, 2023 (JP) 2023-142712

(51) Int. Cl. G03B 11/04

(52) U.S. Cl. CPC G03B 11/043

(57) ABSTRACT

An imaging device includes a housing, a movable unit, a cover, and a magnetic unit. The housing has an opening through which a lens is exposed. The movable unit is inside the housing. The movable unit reciprocates. The cover is outside the housing. The cover covers the opening. The magnetic unit is on the movable unit and the cover. The magnetic unit attracts the cover to the movable unit with a magnetic force. The magnetic unit allows the cover to separate from the movable unit in response to an external force acting on the cover.

### RELATED APPLICATIONS

The present application claims priority to Japanese Application Number 2023-142712, filed Sep. 4, 2023, the disclosure of which is hereby incorporated by reference herein in its entirety.

### BACKGROUND

### Technical Field

The present invention relates to an imaging device.

### Description of the Background

A lens barrel described in Patent Literature 1 includes an aperture (light shielding) unit. The aperture unit includes multiple aperture blades. The multiple aperture blades are driven by a drive motor. The aperture unit is enclosed by an outer frame defining the outer contour of the lens barrel.

### CITATION LIST

### Patent Literature

Patent Literature 1: Japanese Unexamined Patent Application Publication No. 2023-063436

### BRIEF SUMMARY

For an imaging device including a housing accommodating a cover that can cover a lens in a movable manner, the housing is to be disassembled, and the cover is to be detached to replace the cover. This may complicate the replacement of the cover.

One or more aspects of the present invention are directed to an imaging device that allows easy replacement of a cover.

An imaging device according to one embodiment includes a housing, a movable unit, a cover, and a magnetic unit. The housing has an opening through which a lens is exposed. The movable unit is inside the housing. The movable unit reciprocates. The cover is outside the housing. The cover covers the opening. The magnetic unit is on the movable unit and the cover. The magnetic unit attracts the cover to the movable unit with a magnetic force. The magnetic unit allows the cover to separate from the movable unit in response to an external force acting on the cover.

The imaging device according to the above embodiment of the present invention allows easy replacement of the cover.

### BRIEF DESCRIPTION OF DRAWINGS

FIG. 1 is an external view of an imaging device according to a first embodiment in an open state.

FIG. 2 is an external view of the imaging device according to the first embodiment in a closed state.

FIG. 3 is an exploded perspective view of the imaging device in the open state.

FIG. 4 is a perspective view of a base in the imaging device in FIG. 1 as viewed from below.

FIG. 5 is a perspective view of a movable unit in the imaging device in FIG. 1 as viewed from below.

FIG. 6 is a perspective view of the imaging device in the open state showing its internal structure.

FIG. 7 is a perspective view of the imaging device in the closed state showing its internal structure.

FIG. 8 is a cross-sectional view of the imaging device taken along line A-A in FIG. 1.

FIG. 9 is a perspective view of a cover in the imaging device in FIG. 1 as viewed from below.

FIG. 10 is an enlarged cross-sectional view of area S1 in FIG. 8.

FIG. 11 is an external view of an imaging device according to a second embodiment in the open state.

FIG. 12 is an external view of the imaging device according to the second embodiment in the closed state.

FIG. 13 is an exploded perspective view of the imaging device in the open state.

FIG. 14 is a perspective view of a cover in the imaging device in FIG. 11 as viewed from below.

FIG. 15 is a partially enlarged cross-sectional view of the imaging device in FIG. 11.

FIG. 16 is a perspective view of the imaging device in FIG. 11 with its cover and its stoppers in contact with each other.

FIG. 17 is a cross-sectional view of an imaging device according to a modification of the second embodiment.

FIG. 18 is a plan view of an imaging device according to a third embodiment in a first closed state.

FIG. 19 is a plan view of the imaging device according to the third embodiment in a second closed state.

FIG. 20 is a plan view of the imaging device according to the third embodiment in a third closed state.

### DETAILED DESCRIPTION

Embodiments and modifications of the present invention will now be described in detail with reference to the drawings. In the drawings used to describe the embodiments and the modifications, the same reference numerals denote the same or substantially the same components or elements. Such components or elements will basically not be described repeatedly. Unless otherwise specified, the terms such as first and second will be used simply to distinguish the components and will not represent a specific order or sequence.

### Components in First Embodiment

An imaging device 10 may have any use and may be installed at, for example, a hospital, a nursing care facility, a factory, and a store as a surveillance camera or as a monitoring camera. The imaging device 10 is switchable between an imaging state and an imaging-disabled state. More specifically, the imaging device 10 is switchable between a closed state in which light cannot enter an imaging optical system and an open state in which light can enter the imaging optical system. When a component that can transmit light covers the optical imaging system, light can enter the optical imaging system. This state is thus included in the open state.

When the imaging device 10 is switched to the imaging-disabled state (closed state), a person being imaged can recognize that the imaging device 10 has been switched to the imaging-disabled state. For imaging, the imaging device 10 is switchable between a normal mode and a low-light mode based on the brightness level in the surrounding external environment. Imaging in the normal mode is performed when the external environment is bright by using light incident on the imaging optical system. Imaging in the low-light mode is performed when the external environment is dark by emitting illumination light to image a subject irradiated with the illumination light.

### Overall Structure

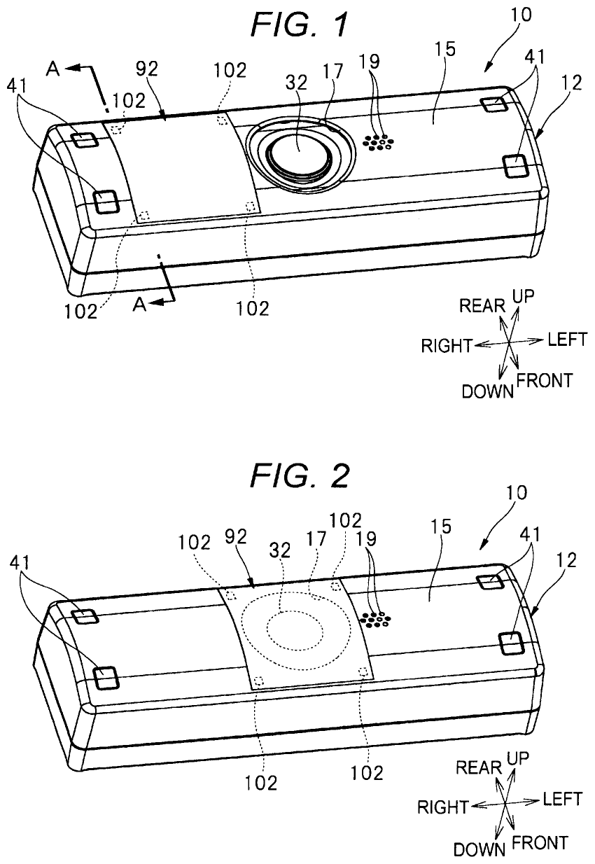

FIG. 1 shows the imaging device 10 in the open state. FIG. 2 shows the imaging device 10 in the closed state. In other words, the imaging device 10 is switchable from the open state to the closed state and from the closed state to the open state.

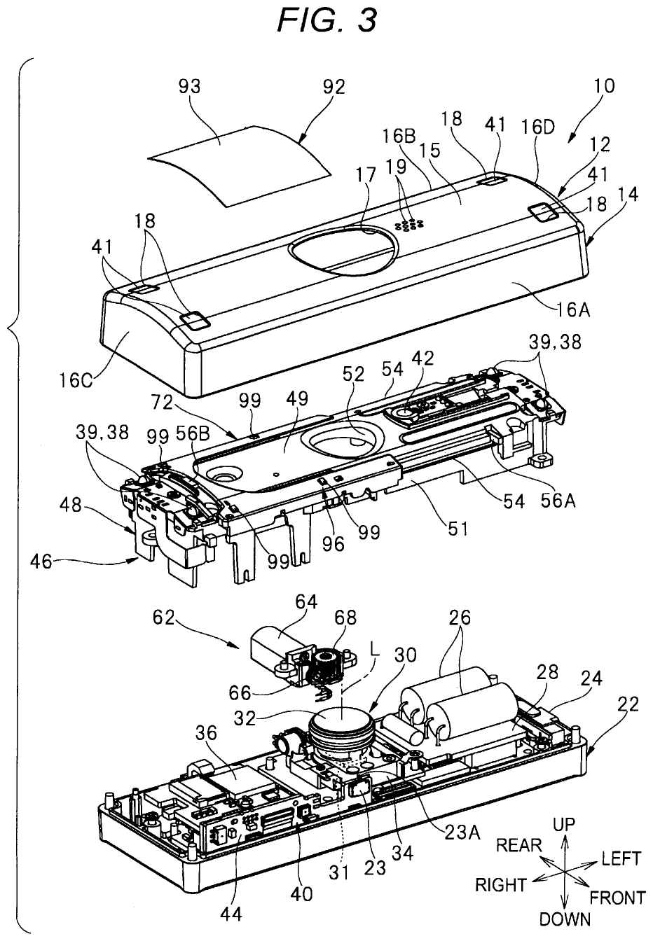

As shown in FIG. 3, the imaging device 10 includes a housing 12, a connector 24, a camera module 30, an antenna 36, illuminators 38, a controller 40, an illuminometer 42, a drive 46, a movable unit 72, a cover 92, and a magnetic unit 96. The imaging device 10 includes a memory slot (not shown).

### Housing

The housing 12 is an example of a housing. The housing 12 includes an upper case 14 and a lower case 22. The upper case 14 includes a rectangular or substantially rectangular top plate 15 and sidewall plates 16A, 16B, 16C, and 16D that adjoin the sides of the top plate 15. The top plate 15 and the sidewall plates 16A, 16B, 16C, and 16D are integrally formed from a synthetic resin. The top plate 15 is curved and has its middle portion located upward from its two ends in the front-rear direction.

Hereafter, the direction in which the upper case 14 in the housing 12 is located may be referred to as being upward, the direction in which the lower case 22 is located as being downward, the direction in which the sidewall plate 16A is located as being frontward, and the direction in which the sidewall plate 16B is located as being rearward. The direction in which the sidewall plate 16C is located may be referred to as being rightward, and the direction in which the sidewall plate 16D is located as being leftward. The up-down or vertical direction, the right-left or lateral direction, and the front-rear direction are perpendicular to one another. The lateral direction is an example of a movement direction of the movable unit 72 (described later). The vertical direction is an example of an optical axis direction of a lens 32 (described later). The front-rear direction is an example of an intersecting direction intersecting with the movement direction and the optical axis direction.

The top plate 15 has a circular first opening 17 connecting the inside and the outside of the housing 12. In other words, the first opening 17 is a through-hole in the top plate 15. The first opening 17 is an example of an opening in the housing. Through the first opening 17, the lens 32 is exposed outside the housing 12. Light (subject light) reflected from an imaging target (subject) (not shown) travels through the first opening 17 into the housing 12 and enters the optical imaging system including the lens 32.

The top plate 15 also has illumination openings 18. Illumination light emitted from the illuminators 38 (described later) travels through the illumination openings 18 to illuminate the imaging target (subject). For example, one illumination opening 18 is located in each of the four corners of the top plate 15 in the front-rear and lateral directions. The illumination openings 18 may not be four illumination openings 18, and may be three or fewer or five or more illumination openings 18. The number of illumination openings 18 is determined based on the number of illuminators 38 in the imaging device 10. The top plate 15 further has multiple openings 19 for collecting sounds. Sounds around the imaging device 10 reach a sound collector (not shown) through the openings 19.

The lower case 22 is fastened to the upper case 14 and closes the bottom (lower portion) of the upper case 14. The lower case 22 is fastened to the upper case 14 with, for example, screws. The lower case 22 contains a position sensor 23 that detects the position of the movable unit 72 in the lateral direction.

The position sensor 23 is located in a front portion of the housing 12 and downward from the movable unit 72. The position sensor 23 includes a contact 23A being a rod extending vertically. The contact 23A comes in contact with part of the movable unit 72 moving in the lateral direction and thus tilts rightward or leftward. More specifically, when the movable unit 72 moves from a closed position (left) to an open position (right), the contact 23A comes in contact with the movable unit 72 and tilts rightward. The contact 23A then comes in contact with an internal first switch. The position sensor 23 then outputs, to the controller 40, a signal indicating that the movable unit 72 is at the open position.

When the movable unit 72 moves from the open position (right) to the closed position (left), the contact 23A comes in contact with the movable unit 72 and tilts leftward. The contact 23 A then comes in contact with an internal second switch. The position sensor 23 then outputs, to the controller 40, a signal indicating that the movable unit 72 is at the closed position. Connector

The imaging device 10 includes the connector 24 connectable to, for example, a power cable or a communication cable. The connector 24 faces an opening in the left sidewall plate of the lower case 22 or an opening in the lower surface of the lower case 22. The connector 24 is electrically connected to a substrate 28 on which a power supply 26 is located.

### Camera Module

The camera module 30 includes an image sensor 31, such as a complementary metal-oxide-semiconductor (CMOS) or a charge-coupled device (CCD), and the lens 32. The lens 32 is, for example, a convex lens and has an optical axis L. The lens 32 includes a center portion (an area nearby the optical axis L) protruding toward the imaging target (subject) with a predetermined curvature. The lens 32 is located above the image sensor 31 and held by a lens holder 34.

The lens 32 focuses subject light entering the first opening 17 onto a light-receiving surface of the image sensor 31. In other words, the lens 32 is an optical member (imaging optical system) that forms an image of the imaging target on the light-receiving surface of the image sensor 31, or at least part of the optical member. The image sensor 31 converts the brightness of light of the image formed by the lens 32 to electric charge and outputs a signal (image signal) corresponding to the resultant electric charge.

### Antenna

The imaging device 10 includes the antenna 36 and can interconnect with other devices through a wireless local area network (LAN). For example, the imaging device 10 can wirelessly transmit a signal (image signal) output from the image sensor 31 to the other devices such as smartphones and tablet terminals. The imaging device 10 can be remotely controlled with another device such as a smartphone.

### Illuminator

The illuminators 38 emit illumination light to illuminate the imaging target for imaging in a dark surrounding environment (or in the low-light mode). Each illuminator 38 includes an illumination light source 39 and an illumination cover 41. The illumination light source 39 is, for example, a light-emitting diode (LED) that emits light with a wavelength in the infrared region (infrared rays or infrared light) under control of the controller 40 (described later). The illumination light source 39 may not emit infrared light as illumination light, and may emit visible light other than infrared light as illumination light. The illumination light source 39 is located on a main base 49 (described later).

The illumination covers 41 are formed from, for example, a light-transmissive resin. Each illumination cover 41 is located adjacent to an illumination light emission portion (upper portion) of the corresponding illumination light source 39. The illumination cover 41 has a surface covering at least the upper portion of the corresponding illumination light source 39. The surface of the illumination cover 41 is fitted to the corresponding illumination opening 18. The illumination cover 41 is attached with its upper surface not protruding upward from the upper surface of the top plate 15. Illumination light emitted from the illumination light sources 39 is emitted outside the imaging device 10.

The imaging device 10 includes, for example, four illuminators 38. The four illuminators 38 are located at the four respective corners of the imaging device 10 in the front-rear and lateral directions. The imaging device 10 may not include four illuminators 38. The imaging device 10 may include three or fewer illuminators 38 or five or more illuminators 38.

### Illuminometer

The illuminometer 42 is, for example, a photoresistor or a photodiode and receives light from the environment (external environment) surrounding the imaging device 10. The illuminometer 42 is located on a base 48 (described later). The illuminometer 42 receives light from the surrounding environment traveling through the openings 19. The illuminometer 42 converts the brightness of received light into electric charge and outputs a signal (luminance signal) corresponding to the resultant electric charge. In other words, the illuminometer 42 functions as a detector to detect the brightness of the environment surrounding the imaging device 10.

### Controller

The controller 40 is mounted on a substrate 44. The substrate 44 is located in the front portion of the housing 12. The controller 40 includes, for example, a central processing unit (CPU), a memory, and other components, and is electrically connected to a substrate on which the image sensor 31 is mounted. The controller 40 is a processor that reads and executes a control program prestored in a storage medium, such as a flash memory, to control various components of the imaging device 10. For example, the controller 40 controls electric power supply from the power supply 26 to the image sensor 31 and an actuator 62.

### Drive

The drive 46 includes the base 48 and the actuator 62. The drive 46 moves the movable unit 72 in the lateral direction to open and close the first opening 17, and controls subject light that enters the lens 32. More specifically, the movable unit 72 is moved between the closed position (first position) at which the first opening 17 is closed and the open position (second position) at which the first opening 17 is open. In other words, for example, the movable unit 72 moved by the drive 46 in the lateral direction is at either the first position at which subject light is restricted from entering the image sensor 31 or the second position at which subject light is allowed to enter the image sensor 31.

### Base

The base 48 is formed from, for example, a synthetic resin, and includes the main base 49 and sub-bases 51 integral with each other. The main base 49 is located upward from the lens 32. The main base 49 is a plate having a predetermined thickness in the vertical direction. The main base 49 is curved along the curvature of the lens 32 with its middle portion located upward from its two ends in the front-rear direction. The sub-bases 51 extend downward from the main base 49. The sub-bases 51 are fastened to the lower case 22.

The main base 49 has a second opening 52. The second opening 52 is a circular through-hole centered at a point through which the optical axis L of the lens 32 extends. Light reflected from the imaging target (subject) travels through the first opening 17 and enters the lens 32 through the second opening 52. The second opening 52 has an outer diameter larger than the outer diameter of the lens 32 and smaller than the outer diameter of the first opening 17.

The movable unit 72, the actuator 62, the illuminators 38, and the illuminometer 42 are located on the main base 49. The movable unit 72, the illuminators 38, and the illuminometer 42 are mounted on the upper surface of the main base 49. In other words, the base 48 functions as a support supporting the movable unit 72 from below. A pair of guide rails 54 are each located on one of the two ends of the main base 49 in the front-rear direction. The pair of guide rails 54 extend linearly in the lateral direction and are parallel to each other. A contact member 56A (or multiple contact members 56A in some embodiments) is located adjacent to the left ends of the guide rails 54. A contact member 56B is located adjacent to the right end of the main base 49.

The contact members 56A and 56B are elastic and rectangular. The contact member 56A has a right side surface that can come in contact with part of the movable unit 72. The contact member 56B has a left side surface that can come in contact with part of the movable unit 72. The movable unit 72 moving leftward or rightward comes in contact with the contact member 56A or the contact member 56B, and is thus restricted from moving.

### Actuator

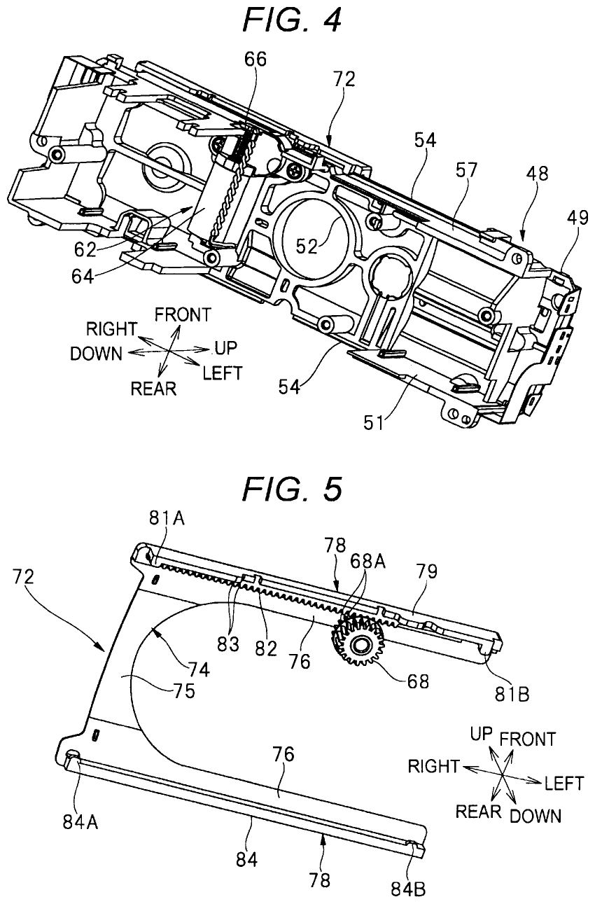

FIG. 4 is a perspective view of the movable unit 72, the base 48, and the actuator 62 with the movable unit 72 at the open position, as viewed from below. The actuator 62 is located on the lower surface of the main base 49.

The actuator 62 functions as a driver to move the movable unit 72 in the lateral direction. The actuator 62 includes a motor 64, a rotational shaft 66, and a gear 68 (FIG. 5). The motor 64 includes, for example, a coil, a yoke, and a magnet, and rotates as controlled by the controller 40 (FIG. 3) with electric power supplied from the power supply 26 (FIG. 3). The motor 64 reverses the rotation direction in response to the direction of a current supplied to the coil. For example, when a current flows through the coil in one direction, the motor 64 rotates clockwise. When a current flows through the coil in the opposite direction, the motor 64 rotates counterclockwise.

The rotational shaft 66 extends in the front-rear direction and is engaged with the gear 68 (FIG. 5). The rotational shaft 66 is driven to rotate as the motor 64 rotates. The gear 68 rotates as the rotational shaft 66 is driven to rotate. As described above, the motor 64 reverses the rotation direction in response to the direction of a supplied current. The rotational shaft 66 and the gear 68 thus reverse their rotation directions as well in response to the direction of a current supplied to the motor 64. The gear 68 is engaged with a rack 82 (FIG. 5) in the movable unit 72.

### Movable Unit

As shown in FIG. 3, the movable unit 72 is located inside the housing 12. The movable unit 72 is located downward from the top plate 15 at a predetermined distance from the top plate 15.

The movable unit 72 shown in FIG. 5 is formed from, for example, a synthetic resin or a metal material. The movable unit 72 is supported on the base 48 (FIG. 4). The movable unit 72 is guided along the pair of guide rails 54 (FIG. 4) and can thus reciprocate (slide) in the lateral direction. The movable unit 72 moving in the lateral direction does not come in contact with the lens 32 (FIG. 3).

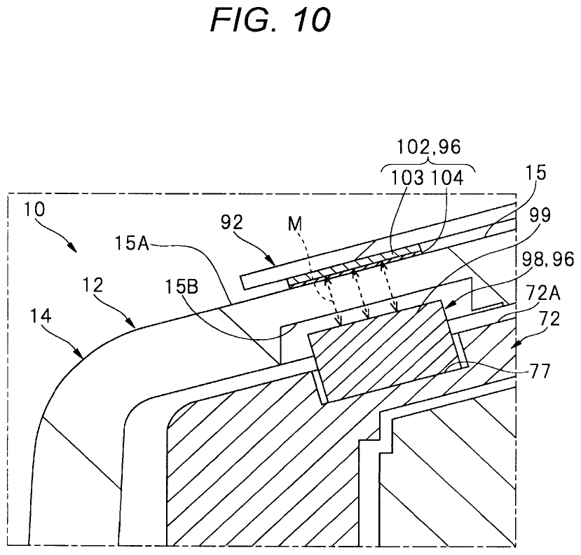

More specifically, the movable unit 72 includes an upper plate 74 having a predetermined thickness in the vertical direction and guide targets 78 adjacent to the two ends of the upper plate 74 in the front-rear direction. The upper plate 74 is U-shaped and is open to the left as viewed from above. The upper plate 74 includes a base portion 75 and a pair of extensions 76. The base portion 75 extends in the front-rear direction. The base portion 75 has its left end cut into an arc that is open to the left. The pair of extensions 76 linearly extend leftward from the front end and the rear end of the base portion 75 in the lateral direction. The pair of extensions 76 include, for example, four recesses 77 (FIG. 10).

Each recess 77 shown in FIG. 10 is rectangular and has long sides in the front-rear direction and short sides in the lateral direction as viewed from above. The recess 77 is open upward. The four recesses 77 are arranged at predetermined distances from one another in the front-rear direction and in the lateral direction.

As shown in FIG. 5, for example, one of the guide targets 78 includes a front wall 79 adjacent to the front extension 76, and the other guide target 78 includes a rear wall 84 adjacent to the rear extension 76. The front wall 79 extends downward from the front end of the corresponding extension 76. The front wall 79 has two ends in the lateral direction including protrusions 81A and 81B protruding rearward. The front guide rail 54 (FIG. 4) is held between the front extension 76 and the protrusions 81A and 81B in the vertical direction. This allows the front guide target 78 to be guided along the guide rail 54.

The front wall 79 has a rear surface with the rack 82. The rack 82 includes multiple teeth 83 protruding rearward and arranged in the lateral direction. The multiple teeth 83 are engaged with part of teeth 68A of the gear 68. When the gear 68 is rotated by the motor 64 (FIG. 4), the movable unit 72 moves in one of two opposite directions along the lateral direction based on the rotation direction of the gear 68. In this manner, the rack 82 functions as a converter that converts a rotational force of the gear 68 to a force for linear movement in the lateral direction when the gear 68 is rotated as the motor 64 rotates.

The rear wall 84 extends downward from the rear end of the corresponding extension 76. The rear wall 84 has two ends in the lateral direction including protrusions 84A and 84B protruding frontward. The rear guide rail 54 (FIG. 4) is held between the rear extension 76 and the protrusions 84A and 84B in the vertical direction. This allows the rear guide target 78 to be guided along the guide rail 54. As described above, the movable unit 72 is movable in the lateral direction between the base 48 and the upper case 14 (FIG. 3).

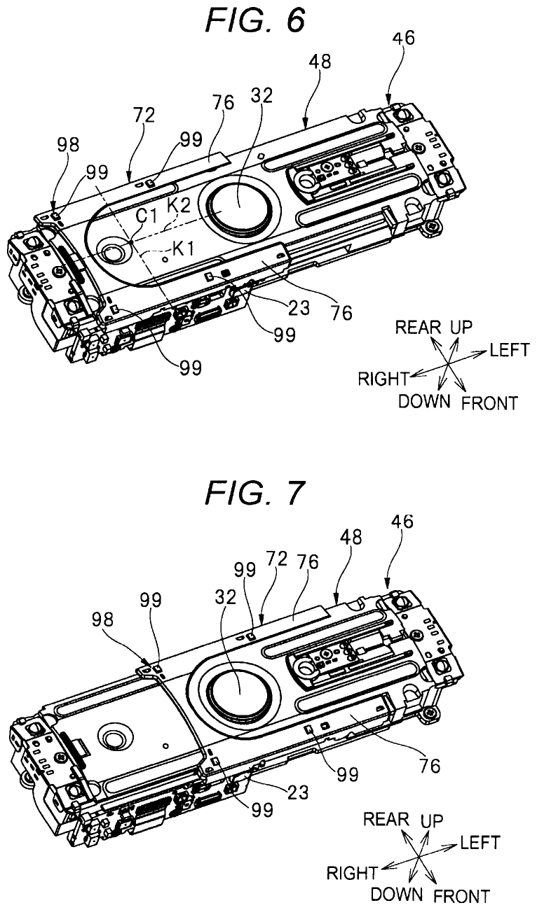

As shown in FIGS. 6 and 7, the movable unit 72 is reciprocable between a middle position of the base 48 in the lateral direction and a right end position of the base 48. With the movable unit 72 at the middle position of the base 48, the arc-shaped cutout in the movable unit 72 is located around the lens 32. More specifically, the movable unit 72 at a leftmost position in its range of movement does not cover the lens 32. With the movable unit 72 at the middle position of the base 48, the lens 32 is located inward from the four recesses 77 (FIG. 10).

The controller 40 shown in FIG. 3 detects the movable unit 72 being at the open position (right end position) in response to a signal input from the first switch in the position sensor 23. The controller 40 detects the movable unit 72 being at the closed position (left end position) in response to a signal input from the second switch in the position sensor 23.

### Cover

The cover 92 shown in FIGS. 3, 8, and 9 includes, for example, a polyethylene terephthalate (PET) film 93 cut into a quadrangle. The cover 92 is a quadrangular plate having a predetermined thickness in the vertical direction. The cover 92 is located outward (upward) from the housing 12. The cover 92 is sized to cover the first opening 17 from above. The cover 92 and the movable unit 72 face each other in the optical axis direction (vertical direction) of the lens 32 with the cover 92 covering the lens 32.

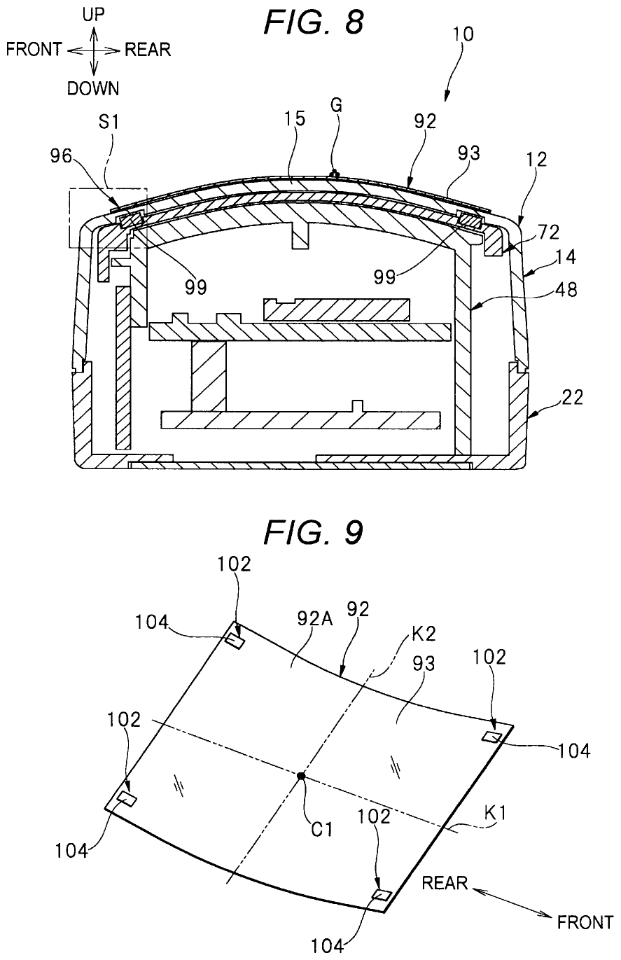

The PET film 93 is an example of a restrictor. The PET film 93 transmits external light traveling toward the lens 32 and restricts foreign matter G (FIG. 8) from entering the housing 12 from outside the cover 92. The foreign matter G includes, for example, dirt, oil, and droplets of water.

The cover 92 has a front end and a rear end extending in the lateral direction. The cover 92 has a right end and a left end extending in the front-rear direction. The cover 92 is attracted to the movable unit 72 under magnetic forces M of the magnetic unit 96 (described later) and moves as the movable unit 72 moves in the lateral direction.

The cover 92 is curved with its middle portion located upward from its two ends in the front-rear direction. The cover 92 has a certain degree of rigidity to an external force acting in the vertical direction. Thus, the cover 92 attached to the upper case 14 remains curved along the outer shape of the top plate 15. The cover 92 is used for, for example, preventing entry of dust, oil, and droplets. The cover 92 transmits light. The imaging device 10 can thus receive light (perform imaging) with the lens 32 both when the cover 92 covers the lens 32 and when the cover 92 does not cover (exposes) the lens 32

In a modification, the cover 92 may include two portions divided in the lateral direction. For example, the cover 92 may include a transparent portion that transmits light and a light shield that absorbs, reflects, and diffuses light. The movable unit 72 may be driven to cause either the transparent portion or the light shield to face the lens 32.

### Magnetic Unit

As shown in FIG. 10, the magnetic unit 96 includes, for example, inner magnetic portions 98 inside the housing 12 and outer magnetic portions 102 outside the housing 12. FIG. 10 is an enlarged cross-sectional view of the inside of area S1 defined by the dot-dash line in FIG. 8. The magnetic unit 96 attracts the cover 92 to the movable unit 72 with the magnetic forces M generated between the inner magnetic portions 98 and the outer magnetic portions 102. The magnitudes of the magnetic forces M generated in the magnetic unit 96 are set to allow the cover 92 to separate from the movable unit 72 in response to an external force applied to the cover 92 by an operator.

### Inner Magnetic Portion

Each inner magnetic portion 98 includes a rectangular magnet 99. Four magnets 99, which are as many as the recesses 77, are included. FIG. 10 shows one of the four magnets 99, and does not show the other three magnets 99. Each magnet 99 has a bottom surface bonded to the bottom surface of the corresponding recess 77. In other words, each inner magnetic portion 98 is fixed to the movable unit 72.

More specifically, each magnet 99 has a lower portion received in the corresponding recess 77. The magnet 99 has an upper portion protruding outward (upward) from an upper surface 72A of the movable unit 72. The upper case 14 includes retracted portions 15B that are recesses to avoid contact with the magnets 99. The four magnets 99 are located in a first direction (rightward) and in a second direction (leftward) along the movement direction (lateral direction) of the movable unit 72 from a middle position C1 (FIG. 9) of the cover 92 in the lateral direction.

As shown in FIG. 6, an imaginary line including the middle position C1 and extending in a direction (front-rear direction) perpendicular to the lateral direction is referred to as a first reference line K1. An imaginary line extending in the lateral direction and perpendicular to the first reference line K1 is referred to as a second reference line K2. Of the four magnets 99, the two front magnets 99 and the two rear magnets 99 are line symmetric with each other with respect to the first reference line K1. Of the four magnets 99, the two right magnets 99 and the two left magnets 99 are line symmetric with each other with respect to the second reference line K2. As described above, sets of two magnets 99 (two sets in total) are symmetric with each other in the lateral direction and in the front-rear direction.

### Outer Magnetic Portion

As shown in FIG. 10, each outer magnetic portion 102 includes a magnetic sticker 103 and a polytetrafluoroethylene (PTFE) sheet 104.

The magnetic sticker 103 is a quadrangular plate having a predetermined thickness in the vertical direction. The shape and size of the magnetic sticker 103 are predetermined to allow the magnetic force M to act and cause the magnetic sticker 103 and the corresponding magnet 99 to attract each other. The magnetic poles of the magnet 99 and the magnetic sticker 103 are not shown in the figure. Four magnetic stickers 103 in total are arranged in one-to-one correspondence with the magnets 99 with the housing 12 between them. The magnetic stickers 103 each has an upper surface and a lower surface each including an adhesive layer (not shown). The upper surfaces of the magnetic stickers 103 are bonded to the lower surface of the cover 92. In other words, the outer magnetic portions 102 are located on the cover 92.

The PTFE sheet 104 is an example of a low friction portion. The PTFE sheet 104 is located between the cover 92 and the housing 12. The PTFE sheet 104 is a quadrangular plate having a predetermined thickness in the vertical direction. The shape and size of the PTFE sheet 104 are predetermined to cover the lower surface of the corresponding magnetic sticker 103. Four PTFE sheets 104 in total are arranged in one-to-one correspondence with the magnets 99. Each PTFE sheet 104 has an upper surface bonded to the lower surface of the corresponding magnetic sticker 103. Each PTFE sheet 104 has a lower surface in contact with an upper surface 15A of the top plate 15.

A first friction coefficient μ1 between the contact surfaces of the PTFE sheet 104 and the housing 12 (upper surface 15A) is lower than a second friction coefficient μ2 of the contact surfaces of the cover 92 and the housing 12. The first friction coefficient μ1 is lower than a third friction coefficient μ3 between the contact surfaces of the magnetic sticker 103 and the upper surface 15A. As described above, the components are preselected to reduce a frictional force between the magnetic sticker 103 and the housing 12. The first friction coefficient μ1, the second friction coefficient μ2, and the third friction coefficient μ3 are not shown in the figures.

As shown in FIG. 9, the cover 92 has a lower surface 92A with four outer magnetic portions 102. The four outer magnetic portions 102 are located in the first direction and in the second direction along the movement direction (lateral direction) of the movable unit 72 (FIG. 10) from the middle position C1 of the cover 92 in the lateral direction. Of the four outer magnetic portions 102, the two front outer magnetic portions 102 and the two rear outer magnetic portions 102 are line symmetric with each other with respect to the first reference line K1. Of the four outer magnetic portions 102, the two right outer magnetic portions 102 and the two left outer magnetic portions 102 are line symmetric with each other with respect to the second reference line K2.

### Effects of First Embodiment

The imaging device 10 according to the first embodiment described above produces the advantageous effects described below. The individual figure numbers are omitted.

In the imaging device 10, the cover 92 is attracted to the movable unit 72 under the magnetic forces of the magnetic unit 96. Thus, when the movable unit 72 located inside the housing 12 moves in the lateral direction, the cover 92 located outside the housing 12 moves in the lateral direction together with the movable unit 72. This allows the cover 92 to open or close the first opening 17, thus exposing or covering the lens 32.

To replace the cover 92 to, for example, change the use of the imaging device 10, the operator applies an external force to the cover 92. This separates the cover 92 from the movable unit 72 and the magnetic unit 96. In this manner, the cover 92 located outside the housing 12 can be replaced without disassembling the imaging device 10.

A new cover 92 to be attached to the housing 12 is attracted to the movable unit 72 under the magnetic forces M of the magnetic unit 96. This attaches the new cover 92 to the housing 12. The cover 92 can thus move as the movable unit 72 moves.

As described above, the imaging device 10 allows the cover 92 to be attached and detached without disassembling the housing 12 and also allows the cover 92 to move as the movable unit 72 moves. This allows easy replacement of the cover 92.

In the imaging device 10, the cover 92 and the movable unit 72 face each other in the optical axis direction (vertical direction) of the lens 32 with the cover 92 covering the lens 32. Unlike the structure including the cover 92 and the movable unit 72 facing each other in the front-rear direction, this structure does not include the cover 92 and the movable unit 72 in the front-rear direction, thus reducing the likelihood of the imaging device 10 being upsized in the front-rear direction.

In the imaging device 10, the cover 92 includes the PET film 93. The PET film 93 transmits light. Imaging can thus be performed with the cover 92 covering the lens 32. With the cover 92 covering the lens 32, the foreign matter G such as dirt comes in contact with the cover 92 and is thus restricted from moving. This restricts the foreign matter G from entering the housing 12 during imaging.

The imaging device 10 includes the PTFE sheets 104 between the cover 92 and the housing 12. In this structure, the frictional force that acts between the cover 92 and the housing 12 is smaller than in the structure including the cover 92 in contact with the upper surface 15A. This reduces a driving force (load) for the movement of the cover 92 when the cover 92 is moved in the lateral direction as the movable unit 72 moves.

### Components in Second Embodiment

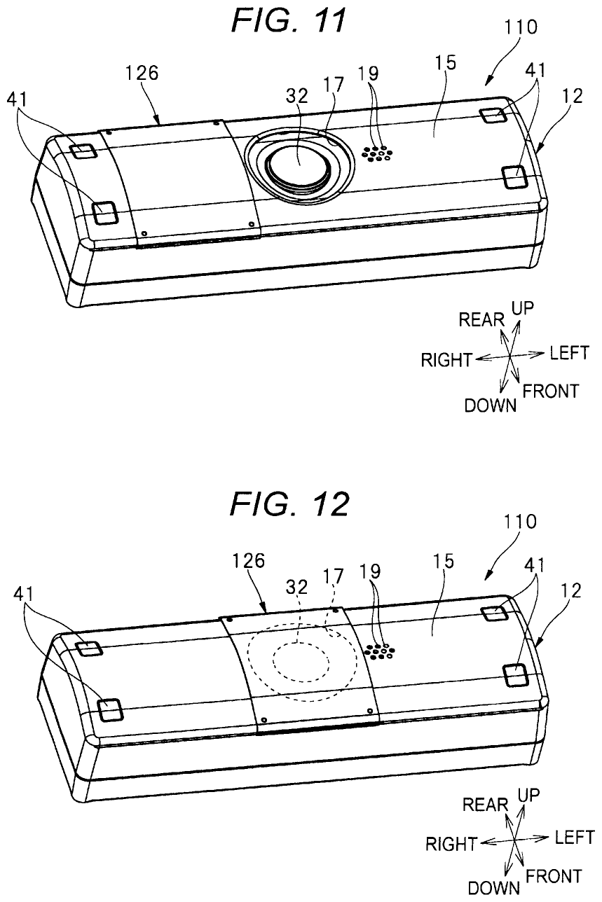

FIG. 11 shows an imaging device 110 according to a second embodiment in the open state. FIG. 12 shows the imaging device 110 in the closed state. The imaging device 110 is switchable from the open state to the closed state. The imaging device 110 is switchable from the closed state to the open state. The same reference numerals denote the same or substantially the same components or elements of the imaging device 10 (FIG. 3) according to the first embodiment. Such components will not be described.

### Overall Structure

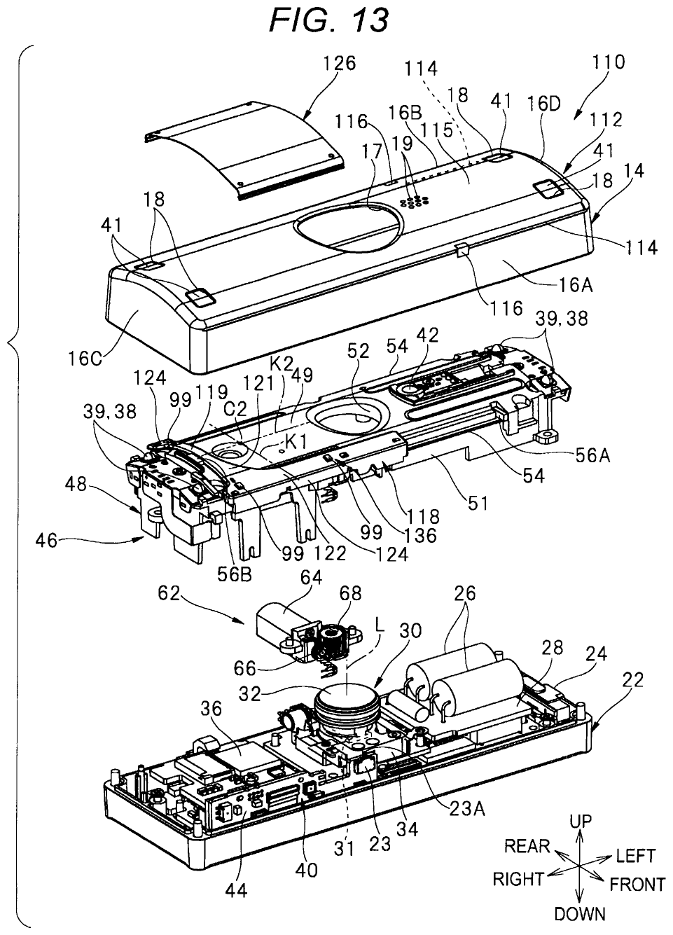

As shown in FIG. 13, the imaging device 110 includes a housing 112, stoppers 116, a movable unit 118, a cover 126, and magnetic units 136. The imaging device 110 has the same structure as the imaging device 10 (FIG. 3) except the housing 112, the stoppers 116, the movable unit 118, the cover 126, and the magnetic units 136.

### Housing

The housing 112 includes a front portion and a rear portion each having one groove 114. The housing 112 has the same structure as the housing 12 except the two grooves 114. The grooves 114 are located on the boundary between a top plate 115 and the sidewall plate 16A and on the boundary between the top plate 115 and the sidewall plate 16B. The grooves 114 extend linearly in the lateral direction. The grooves 114 are recessed toward the internal space of the housing 12. The grooves 114 each have two open ends in the lateral direction. As described above, the housing 112 has the two grooves 114 extending in a movement direction of the movable unit 118.

### Stopper

The two grooves 114 receive the respective stoppers 116. The stoppers 116 are formed from, for example, rubber. Each stopper 116 is fitted in and bonded to a recess on part of the corresponding groove 114. The stoppers 116 are located leftward from the first opening 17. The stoppers 116 come in contact with the left end of the cover 126 (described later) to stop the cover 126 at a predetermined position.

### Movable Unit

The movable unit 118 is located inside the housing 112. The movable unit 118 is located downward from the top plate 115 at a predetermined distance from the top plate 115. The movable unit 118 is formed from, for example, a synthetic resin or a metal material. The movable unit 118 is supported on the base 48. The movable unit 118 is guided along the pair of guide rails 54 and is thus reciprocable (slidable) in the lateral direction.

The movable unit 118 is driven by the actuator 62. The movable unit 118 is located to avoid the first opening 17 and the lens 32. The movable unit 118 moving in the lateral direction thus does not come in contact with the lens 32. More specifically, the movable unit 118 includes an upper plate 119 having a predetermined thickness in the vertical direction and guide targets 124 extending from the two ends of the upper plate 119 in the front-rear direction.

The upper plate 119 has an L-shaped outer shape as viewed from above. The upper plate 119 includes a base portion 121 and one extension 122. The base portion 121 extends in the front-rear direction at the right end of the upper plate 119. The base portion 121 has a left end cut into an arc that is open to the left. The extension 122 linearly extends leftward from the front end of the base portion 121 in the lateral direction. The base portion 121 has two recesses 77 (FIG. 15) spaced from each other in the front-rear direction. The extension 122 has two recesses 77 spaced from each other in the lateral direction. In other words, the movable unit 118 has three recesses 77.

The guide targets 124 are located adjacent to the front end of the extension 122 and the rear end of the base portion 121. The guide targets 124 each hold the front or rear guide rail 54 from above and from below in the vertical direction. The guide targets 124 are thus guided along the guide rails 54 in the lateral direction. The front guide target 124 has an inner surface with the rack 82 (FIG. 5). The rack 82 functions as a converter that converts a rotational force of the gear 68 to a force for linear movement in the lateral direction when the gear 68 is rotated as the motor 64 rotates.

The movable unit 118 is reciprocable between the middle position of the base 48 in the lateral direction and the right end position of the base 48. With the movable unit 118 at the middle of the base 48, an arc-shaped cutout in the movable unit 118 is located around the lens 32. More specifically, the movable unit 118 at a leftmost position in its range of movement does not cover the lens 32. With the movable unit 118 at the middle position of the base 48, the lens 32 is located inward from (closer to the center than) the three recesses 77 (FIG. 15).

The controller 40 detects the movable unit 118 being at the open position (right end position) in response to a signal input from the first switch in the position sensor 23. The controller 40 detects the movable unit 118 being at the closed position (left end position) in response to a signal input from the second switch in the position sensor 23.

### Cover

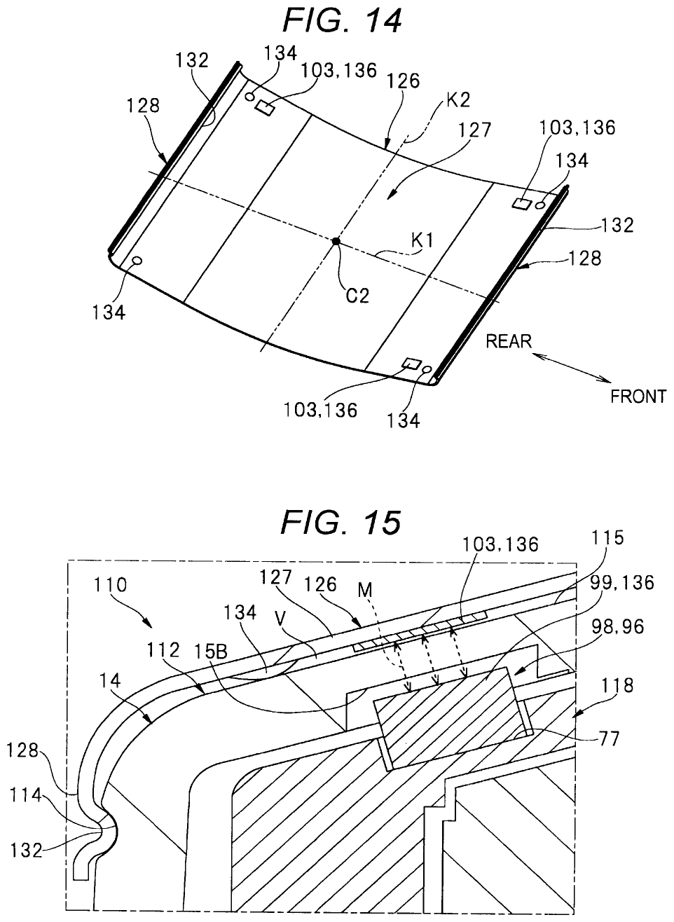

As shown in FIG. 14, the cover 126 is, for example, a magnetic iron sheet. The cover 126 includes an upper plate 127 covering the top plate 115 (FIG. 13), side walls 128 adjacent to the two ends of the upper plate 127 in the front-rear direction, contact portions 132 adjacent to the side walls 128, three magnetic stickers 103, and four protruding portions 134. The cover 126 with magnetic units is not limited to the cover 126 with magnets (magnetic stickers 103), which are magnetic. The cover 126 with magnetic units includes the cover 126 formed from a magnetic material.

### Upper Plate

The upper plate 127 is curved along the shape of the top plate 115 (FIG. 13). More specifically, the upper plate 127 is curved with its middle portion located upward from its two ends in the front-rear direction. The side walls 128 are located adjacent to the two ends of the upper plate 127 in the front-rear direction. The side walls 128 extend downward from the two ends of the upper plate 127 in the front-rear direction.

### Contact Portion

The contact portion 132 shown in FIG. 15 protrudes from a lower end portion of the side wall 128 toward the groove 114. The contact portion 132 has a trapezoidal cross section. The contact portions 132 are in contact with the grooves 114 in the front-rear direction. The contact portions 132 are guided along the grooves 114, thus allowing the cover 126 to be guided in the lateral direction (movement direction).

### Protruding Portion

The protruding portions 134 protrude from the lower surface of the upper plate 127 toward the top plate 115. The protruding portions 134 are, for example, hemispherical. The protruding portions 134 each have a top in contact with the housing 112 (top plate 115), thus defining a space V between the cover 126 and the top plate 115. The space V has a size in the vertical direction greater than the thickness of the magnetic sticker 103 in the vertical direction. In other words, the protruding portions 134 are in contact with the housing 112, but the magnetic stickers 103 are not in contact with the housing 112.

The cover 126 receives attractive forces (magnetic forces M) of the magnetic units 136 (described later). In other words, the cover 126 is attracted to the movable unit 118 under the magnetic forces M. The cover 126 thus moves together with the movable unit 118 moving in the lateral direction. The cover 126 does not transmit light. Thus, the imaging device 110 cannot receive light (perform imaging) with the lens 32 when the cover 126 covers the lens 32 (FIG. 13). The imaging device 110 can receive light (perform imaging) with the lens 32 when the cover 126 does not cover (exposes) the lens 32.

### Magnetic Unit

As shown in FIG. 14, three magnetic units 136 are located on the cover 126.

As shown in FIG. 15, each magnetic unit 136 includes, for example, the magnet 99 inside the housing 112 and the magnetic sticker 103 outside the housing 112. The magnetic units 136 attract the cover 126 to the movable unit 118 with the magnetic forces M. The magnitudes of the magnetic forces M generated in the magnetic units 136 are set to allow the cover 126 to separate from the movable unit 118 in response to an external force being applied to the cover 126 by the operator.

The three magnets 99 shown in FIG. 13 attract the cover 126 to the movable unit 118. The three magnets 99 are located in a first direction and in a second direction along the movement direction (lateral direction) of the movable unit 118 from a middle position C2 (FIG. 14) of the cover 126 in the lateral direction. Of the three magnets 99, the two magnets 99 located in a front end portion of the movable unit 118 are line symmetric with each other with respect to the first reference line K1 including the middle position C2. The two magnets 99 arranged in the front-rear direction in a right end portion of the movable unit 118 are line symmetric with each other with respect to the second reference line K2 including the middle position C2.

The three magnetic stickers 103 shown in FIG. 14 are located in a first direction and in a second direction along the lateral direction from the middle position C2 of the cover 126. Of the three magnetic stickers 103, the two magnetic stickers 103 located in a front end portion of the cover 126 are line symmetric with each other with respect to the first reference line K1 including the middle position C2. The two magnets 99 located in the right end portion of the movable unit 118 are line symmetric with each other with respect to the second reference line K2 including the middle position C2.

### Effects of Second Embodiment

The imaging device 110 according to the second embodiment described above produces the advantageous effects described below.

As shown in FIG. 15, in the imaging device 110, the contact portions 132 are in contact with the grooves 114. The cover 126 is thus attached to the housing 112 to hold the housing 112. The contact portions 132 are guided along the grooves 114, thus allowing the cover 126 to move in the lateral direction. The cover 126 is moved in the lateral direction as the movable unit 118 moves.

To replace the cover 126 with another cover, the operator holds the cover 126 and slides the cover 126 rightward. In response to an external force acting on the cover 126 exceeding the attractive forces resulting from the magnetic forces M, the cover 126 is shifted rightward from the position at which the cover 126 faces the movable unit 118. The cover 126 is then separated outside through the right ends of the grooves 114.

To attach the other cover to the housing 112, the operator places the contact portions 132 in the other cover into contact with the grooves 114 and slides the other cover leftward. The other cover then receives the attractive forces resulting from the magnetic forces M, and can move as the movable unit 118 moves (move integrally with the movable unit 118).

As described above, in the imaging device 110, the contact portions 132 and the grooves 114 are in contact with each other, thus reducing the likelihood that the cover 126 is detached from the housing 112 in the vertical direction. Additionally, the grooves 114 have the open right ends. This allows the cover 126 to be slid rightward and detached for replacement with another cover.

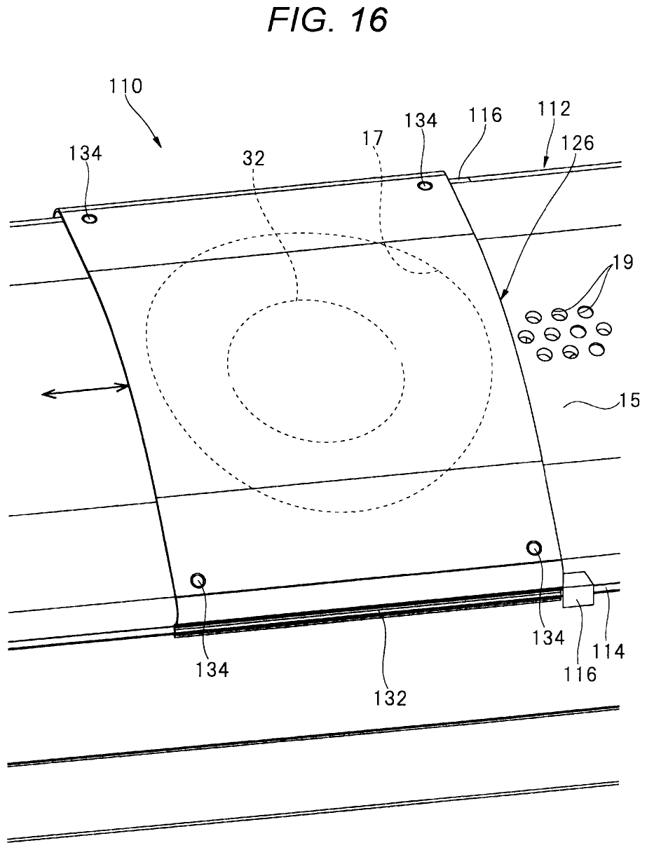

As shown in FIG. 16, in the imaging device 110, the two stoppers 116 come in contact with the left front end and the left rear end of the cover 126 when the cover 126 is moved leftward. This stops the cover 126 at the predetermined position (e.g., a position at which the cover 126 faces the lens 32). In this manner, the stoppers 116 restrict the cover 126 from excessively moving leftward, thus reducing the likelihood of a leftward positional deviation of the cover 126 when the movable unit 118 (FIG. 13) moves leftward with a large acceleration force.

As shown in FIG. 15, in the imaging device 110, the protruding portions 134 on the cover 126 are in contact with the top plate 115, thus defining the space V between the cover 126 and the housing 112. This creates a clearance between each magnetic sticker 103 and the top plate 115. In other words, the magnetic stickers 103 and the top plate 115 are not in direct contact with each other. This prevents a frictional force resulting from the magnetic stickers 103 and the top plate 115 in contact with each other from acting as a load when the cover 126 moves.

The protruding portions 134 are hemispherical. The protruding portions 134 each have the top in contact with the top plate 115. The cover 126 and the housing 112 are thus nearly in point contact with each other, reducing a load on the cover 126 and the movable unit 118 when the cover 126 moves.

As shown in FIG. 13, the three magnets 99 are located in a first direction (rightward) and in a second direction (leftward) along the movement direction (lateral direction) of the movable unit 118 from the middle position C2 of the cover 126. This reduces the likelihood of a positional deviation of the cover 126 in a direction intersecting with the lateral direction when the cover 126 moves to the closed position at which the cover 126 faces the lens 32. Further, of the three magnets 99, the two magnets 99 arranged in the front-rear direction are line symmetric with each other with respect to the second reference line K2. This further reduces a positional deviation of the cover 126 in the front-rear direction.

The two front magnets 99 of the three magnets 99 are line symmetric with each other with respect to the first reference line K1. This structure can support (hold) the two front ends of the cover 126 in the lateral direction with an equal force, unlike the structure including the two front magnets 99 that are not line symmetric with each other with respect to the first reference line K1.

### Modification of Second Embodiment

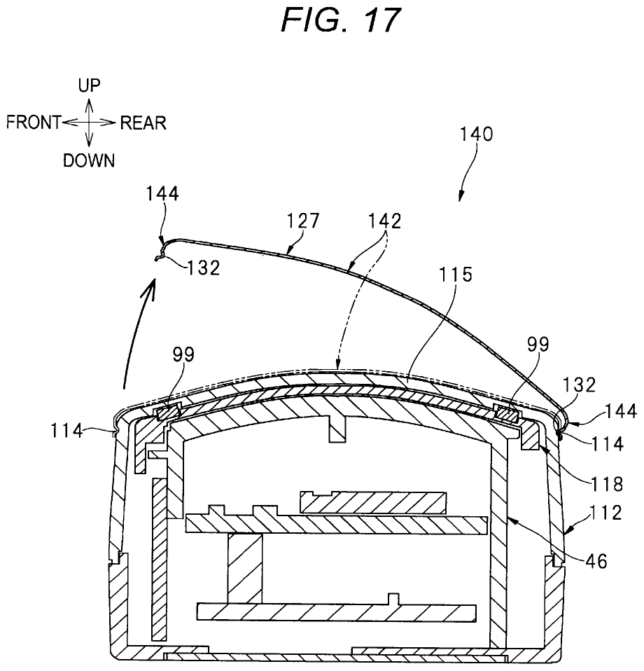

FIG. 17 shows a cross section of an imaging device 140 that is a modification of the imaging device 110 (FIG. 13) according to the second embodiment. The same reference numerals denote the same components of the imaging device 110, and such components will not be described. The imaging device 140 differs from the imaging device 110 in that the cover 126 (FIG. 13) is replaced with a cover 142. For the other components, the imaging device 140 has the same structure as the imaging device 110. In FIG. 17, the protruding portions 134 and the magnetic stickers 103 (FIG. 15) are not shown.

The imaging device 140 includes the cover 142. The cover 142 is an iron sheet. The cover 142 includes the upper plate 127 covering the top plate 115, side walls 144 adjacent to the two ends of the upper plate 127 in the front-rear direction, the contact portions 132 adjacent to the side walls 144, the three magnetic stickers 103, and the four protruding portions 134 (FIG. 15).

The side walls 144 extend downward from the two ends of the upper plate 127 in the front-rear direction. The side walls 144 are leaf springs and elastically deformable at least in the front-rear direction. In other words, the contact portions 132 are located in the elastically deformable side walls 144 of the cover 142.

To replace the cover 142 with another cover in the imaging device 140, the front or rear side wall 144 is elastically deformed outward in the front-rear direction, thus separating the contact portions 132 from the grooves 114. This structure allows the cover 142 to be detached more easily than a structure in which the cover 142 is slid in the lateral direction. To attach the other cover, with the contact portion 132 and the groove 114 in a first portion of the cover in the front-rear direction in contact with each other, the side wall 144 in a second portion of the cover in the front-rear direction is deformed, and the contact portion 132 and the groove 114 in the second portion of the cover are placed in contact with each other. This attaches the other cover to the housing 112. In this manner, the cover 142 can be replaced without being slid in the lateral direction.

### Components in Third Embodiment

FIGS. 18, 19, and 20 show an imaging device 150 according to a third embodiment. The same reference numerals denote the same or substantially the same components or elements of the imaging device 10 (FIG. 3). Such components will not be described.

### Overall Structure

The imaging device 150 includes a housing 152, a movable unit 154, an actuator 162, a cover 172, and the magnetic unit 96.

### Housing

The housing 152 is an example of the housing. The housing 152 is different from the housing 12 (FIG. 3) in the length in the lateral direction alone. The housing 152 is longer than the housing 12 in the lateral direction. The housing 152 includes the top plate 15 and the first opening 17.

### Movable Unit

The movable unit 154 includes a first movable unit 156 and a second movable unit 158. The first movable unit 156 is U-shaped and is open to the left. The second movable unit 158 is U-shaped and is open to the right. The first movable unit 156 is located rightward from the second movable unit 158.

### Actuator

The actuator 162 includes a first linear slider 164 and a second linear slider 166. The first movable unit 156 is attached to the first linear slider 164. In other words, the first movable unit 156 is movable in the lateral direction when the first linear slider 164 is driven. The first movable unit 156 has its right end set as a reference portion for determining a stop position of the first movable unit 156 in the lateral direction. The first movable unit 156 can move to and stop at three stop positions in the lateral direction. The three stop positions of the reference portion of the first movable unit 156 are a position P1, a position P2, and a position P3 in this order from the right to the left.

The second movable unit 158 is attached to the second linear slider 166. In other words, the second movable unit 158 is movable in the lateral direction when the second linear slider 166 is driven. The second movable unit 158 has its left end set as a reference portion for determining a stop position of the second movable unit 158 in the lateral direction. The second movable unit 158 can move to and stop at two stop positions in the lateral direction. The two stop positions of the reference portion of the second movable unit 158 are a position P4 and a position P5 in this order from the right to the left. The position P1 to the position P5 are arranged in sequence from the right to the left. The position P1 to the position P5 are spaced from one another at, for example, unequal distances.

### Cover

The cover 172 is an example of the restrictor. The cover 172 includes a first filter 174, a second filter 176, and a third filter 178. In other words, the cover 172 includes as many filters as the stop positions (three), which are the position P1, the position P2, and the position P3. The first filter 174 is painted black and blocks light.

The second filter 176 has the same structure as the PET film 93 (FIG. 9). More specifically, the second filter 176 transmits light traveling toward the lens 32 and restricts the foreign matter G (FIG. 8) from entering the housing 152 from outside the second filter 176.

The third filter 178 is, for example, a bandpass filter that transmits light in a predetermined frequency range (e.g., infrared light).

### Magnetic Unit

The magnetic unit 96 includes, for example, twelve outer magnetic portions 102 (FIG. 9). Four outer magnetic portions 102 are located on each of the first filter 174, the second filter 176, and the third filter 178. The magnetic unit 96 includes, for example, twelve inner magnetic portions 98 (FIG. 10). Eight inner magnetic portions 98 are located on the first movable unit 156. Four inner magnetic portions 98 are located on the second movable unit 158.

### Effects of Third Embodiment

As shown in FIG. 18, in the imaging device 150, the first filter 174 covers the lens 32 to block light when the first movable unit 156 is at the position P3. This state is referred to as a first closed state. The second movable unit 158 is at the position P5.

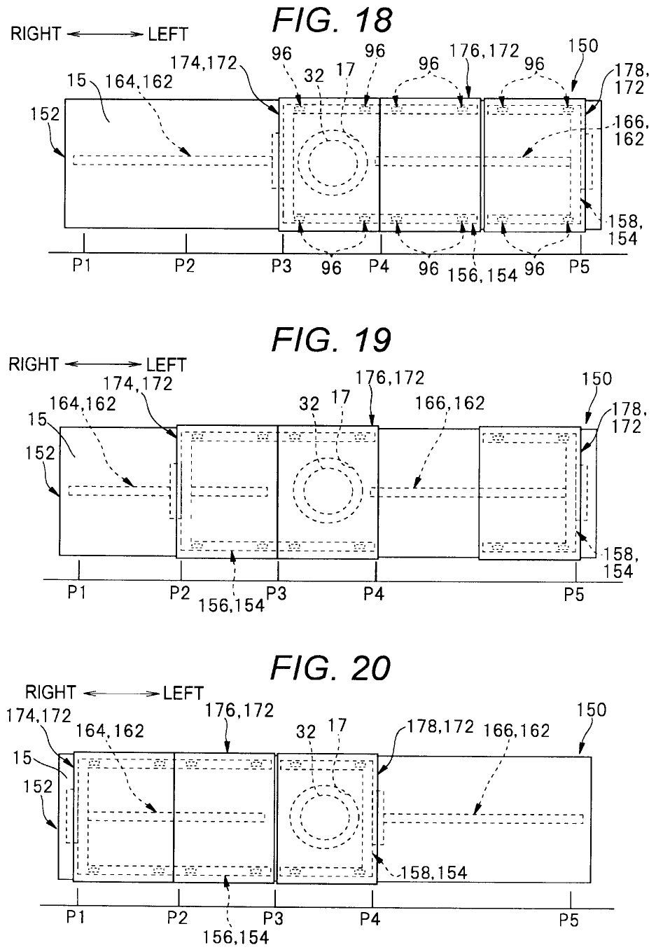

As shown in FIG. 19, when the first movable unit 156 is moved to and stopped at the position P2 as the first linear slider 164 is driven, the second filter 176 covers the lens 32. This state is referred to as a second closed state. The second filter 176 transmits light, but restricts the foreign matter G (FIG. 8) from entering the housing 152. Subsequently, when the first movable unit 156 is moved to and stopped at the position P1 as the first linear slider 164 is driven, the lens 32 is exposed (uncovered). The lens 32 being uncovered is not shown in the figures.

As shown in FIG. 20, when the second movable unit 158 is moved from the position P5 to the position P4 and stopped as the second linear slider 166 is driven, the third filter 178 covers the lens 32. This state is referred to as a third closed state. The third filter 178 restricts the foreign matter G from entering the housing 152. The third filter 178 is a bandpass filter and transmits light in the predetermined frequency range. This reduces the likelihood that noise caused by unintended light appears in a video when, for example, the imaging device 150 is used outdoors. After the third filter 178 is used, the second movable unit 158 is moved to the position P5 and stopped, exposing the lens 32.

As described above, in the imaging device 150, the first movable unit 156 can move to the three stop positions and stop at the three stop positions. This allows as many filters (the first filter 174, the second filter 176, and the third filter 178) as the stop positions to face the lens 32. The imaging device 150 can thus be used for multiple purposes (e.g., for preventing entry of light, oil, droplets, and dust).

Further, the imaging device 150 includes the third filter 178 as a bandpass filter, thus reducing the likelihood that specific light affects the state of a video (image) during imaging. For example, this structure can block harmful light, such as ultraviolet rays, thus reducing the likelihood of an image being reddish or reducing the likelihood that infrared light used in the low-light mode is reflected from the subject to be included in an image. The structure can also reduce the entire light intensity in the same manner as a neutral density (ND) filter, thus reducing the likelihood of halation in an image.

### Modifications

The imaging device according to one or more embodiments of the present invention is not limited to any of the first, second, and third embodiments described above, and can be modified variously without departing from the spirit and scope of the invention.

The movable unit 72, 118, or 154 may face the cover 92, 126, 142, or 172 in a direction intersecting with the optical axis direction of the lens 32, rather than in the optical axis direction of the lens 32. The cover 92 may include no restrictor.

The movable unit 154 may have two stop positions or four or more stop positions, rather than three stop positions. The number of stop positions may be different from the number of filters. The multiple filters may not include a bandpass filter.

The grooves 114 may be three or more grooves 114, rather than two grooves 114. The stoppers 116 received in the grooves 114 may not be fixed to the grooves 114, and may be detachable from the grooves 114.

For the cover 126 having high rigidity to an external force acting on the cover 126, the cover 126 may not include the protruding portions 134. The protruding portions 134 may not be hemispherical, and may have another shape such as a truncated cone.

For the cover 126 formed from a magnetic material that can be sufficiently attracted under the magnetic forces M of the magnets 99, the cover 126 may not include the magnetic stickers 103.

The multiple magnets 99 may not be symmetric with each other in the lateral direction and in the front-rear direction. For example, three magnets 99 may be located to form an equilateral triangle, with two of the magnets 99 located frontward and one of the magnets 99 located rearward.

The low friction portion may be, for example, a coating layer containing a fluororesin on the surface of the housing 12, rather than the PTFE sheets 104.

The technique according to one or more embodiments of the present invention may provide the structure described below.
(1) An imaging device, comprising:
a housing having an opening through which a lens is exposed;
a movable unit inside the housing, the movable unit being configured to reciprocate;
a cover outside the housing, the cover being configured to cover the opening; and a magnetic unit on the movable unit and the cover, the magnetic unit attracting the cover to the movable unit with a magnetic force, the magnetic unit allowing the cover to separate from the movable unit in response to an external force acting on the cover.
(2) The imaging device according to (1), wherein
the cover and the movable unit face each other in an optical axis direction of the lens with the cover covering the lens.
(3) The imaging device according to (1) or (2), wherein
the cover includes a restrictor configured to transmit light traveling toward the lens and restrict foreign matter from entering the housing from outside the cover.
(4) The imaging device according to (3), wherein
the movable unit moves to and stops at a plurality of stop positions, and
the restrictor includes a plurality of filters, and the plurality of filters are as many as the plurality of stop positions.
(5) The imaging device according to (4), wherein
at least one of the plurality of filters is a bandpass filter.
(6) The imaging device according to any one of (1) to (5), wherein
the housing has a plurality of grooves extending in a movement direction of the movable unit, and
the cover includes contact portions in contact with the plurality of grooves, and the cover is guided in the movement direction.
(7) The imaging device according to (6), wherein
the contact portions are located in elastically deformable portions of the cover.
(8) The imaging device according to (6) or (7), further comprising:
stoppers in the plurality of grooves to stop the cover at a predetermined position.
(9) The imaging device according to any one of (1) to (8), wherein
the cover includes a protruding portion in contact with the housing and defining a space between the cover and the housing.
(10) The imaging device according to (9), wherein
the protruding portion is hemispherical.
(11) The imaging device according to any one of (1) to (10), wherein
the magnetic unit includes a plurality of magnets attracting the cover to the movable unit, and
the plurality of magnets are located in a first direction and in a second direction along a movement direction of the movable unit from a middle position of the cover in the movement direction.
(12) The imaging device according to (11), wherein
at least two of the plurality of magnets are line symmetric with each other with respect to a first reference line including the middle position and extending in a direction perpendicular to the movement direction.
(13) The imaging device according to (11) or (12), wherein
at least two of the plurality of magnets are line symmetric with each other with respect to a second reference line extending in the movement direction and perpendicular to the first reference line.
(14) The imaging device according to any one of (1) to (13), further comprising:
a low friction portion between the cover and the housing,
wherein a first friction coefficient between contact surfaces of the low friction portion and the housing is lower than a second friction coefficient between contact surfaces of the cover and the housing.

What is claimed is:

1. An imaging device, comprising:
a housing having an opening through which a lens is exposed;
a movable unit inside the housing, the movable unit being configured to reciprocate;
a cover outside the housing, the cover being configured to cover the opening; and
a magnetic unit on the movable unit and the cover, the magnetic unit attracting the cover to the movable unit with a magnetic force, the magnetic unit allowing the cover to separate from the movable unit in response to an external force acting on the cover.

2. The imaging device according to claim 1, wherein
the cover and the movable unit face each other in an optical axis direction of the lens with the cover covering the lens.

3. The imaging device according to claim 1, wherein
the cover includes a restrictor configured to transmit light traveling toward the lens and restrict foreign matter from entering the housing from outside the cover.

4. The imaging device according to claim 3, wherein
the movable unit moves to and stops at a plurality of stop positions, and
the restrictor includes a plurality of filters, and the plurality of filters are as many as the plurality of stop positions.

5. The imaging device according to claim 4, wherein
at least one of the plurality of filters is a bandpass filter.

6. The imaging device according to claim 1, wherein
the housing has a plurality of grooves extending in a movement direction of the movable unit, and
the cover includes contact portions in contact with the plurality of grooves, and the cover is guided in the movement direction.

7. The imaging device according to claim 6, wherein
the contact portions are located in elastically deformable portions of the cover.

8. The imaging device according to claim 6, further comprising:
stoppers in the plurality of grooves to stop the cover at a predetermined position.

9. The imaging device according to claim 1, wherein
the cover includes a protruding portion in contact with the housing and defining a space between the cover and the housing.

10. The imaging device according to claim 9, wherein
the protruding portion is hemispherical.

11. The imaging device according to claim 1, wherein
the magnetic unit includes a plurality of magnets attracting the cover to the movable unit, and
the plurality of magnets are located in a first direction and in a second direction along a movement direction of the movable unit from a middle position of the cover in the movement direction.

12. The imaging device according to claim 11, wherein
at least two of the plurality of magnets are line symmetric with each other with respect to a first reference line including the middle position and extending in a direction perpendicular to the movement direction.

13. The imaging device according to claim 12, wherein
at least two of the plurality of magnets are line symmetric with each other with respect to a second reference line extending in the movement direction and perpendicular to the first reference line.

14. The imaging device according to claim 1, further comprising:
a low friction portion between the cover and the housing,
wherein a first friction coefficient between contact surfaces of the low friction portion and the housing is lower than a second friction coefficient between contact surfaces of the cover and the housing.
